(19) United States
(12) Patent Application Publication
(10) Pub. No.: US 2004/0203659 A1
(43) Pub. Date: Oct. 14, 2004

(54) Apparatus and method for changing instant messaging presence relative to a calendar function

(76) Inventor: Jeffrey Clinton Mikan, Cumming, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/313,362

(22) Filed: Dec. 6, 2002

(51) Int. Cl. H04M 3/42; H04M 3/00

(52) U.S. Cl. 455/414.1; 455/418

(57) ABSTRACT

The present invention is an apparatus and method for changing the presence of a user profile active on a communication device on a telecommunications network relative to a calendar function for the communication device. In the first embodiment, the communication device first receives an indication that an event in the calendar function for the communication device has occurred. The communication device next determines the new presence corresponding to the event, and communicates the new presence to the telecommunications network. In the second embodiment, the communication device is coupled to a client device. The client device receives an indication that an event has occurred, and then determines the new presence corresponding to the event.

### FIELD OF THE INVENTION

The present invention generally relates to the field of telecommunications, and more particularly, relates to an apparatus and method for changing the presence of a user profile on a telecommunications network relative to the calendar function of the communication device.

### BACKGROUND OF THE INVENTION

Instant messaging services, accessible via a computer device or other communication device, enable users of such services to exchange messages or information with each other in near real-time. A feature of instant messaging services is a personal list, sometimes referred to as a “buddy list,” which includes identification of other users with whom the user frequently communicates via the instant messaging services. The availability status of other users on the personal list, known as the instant messaging presence of each user profile, includes not only “online” or “offline,” but user-controlled statuses such as “be right back,” “at work,” or “eating dinner.” Generally, the user-controlled statuses may be changed in response to an action received by the user interface, such as receipt of a selection of an instant messaging presence via a drop-down menu presented on the display of the communication device.

Many communication devices include a calendar function, or another type of personal information manager (“PIM”), that will allow a user to record events and appointments in the communication device. Occasionally, a user may desire for the other users on the personal list to know that the user is attending an event scheduled in the calendar function. To accomplish this, the user could make the selection of the instant messaging presence for the user profile reflecting the event, such as “in a meeting,” via the user interface on the communication device at the time of the event. Upon receipt of the change in instant messaging presence, the communication device would communicate a signal representative of the new instant messaging presence for the user profile to the instant messaging server via the telecommunications network. Then, upon receipt of this signal, the instant messaging server would then communicate via the telecommunications network the new instant messaging presence to the other users' personal lists by publishing the instant messaging presence on the display of each communication device.

However, there are many inconveniences posed to the user by this process. For instance, users typically have several events scheduled in their calendar for each day. For many of these events, the user may also desire to change the instant messaging presence of the communication device at the time of the event to maintain the accuracy of the instant messaging presence. Currently, there is no mechanism for automatically changing the instant messaging presence of a user profile relative to the occurrence of an event in the calendar function of the communication device. Thus, in such a situation, the user must remember to change the instant messaging presence each time the user attends an event scheduled in the calendar of the communication device. Constantly changing the instant messaging presence for each event in the calendar will not only become burdensome, but time consuming for the user.

This process may cause added aggravation because the user may forget to change the instant messaging presence of the user profile logged into the communication device for every event in the calendar. Another aggravation may be that the user is in too much of a hurry to make the change at the time of the event. In both of these predicaments, the published instant messaging presence will be inaccurate if the event scheduled in the calendar renders the user unavailable for instant messaging purposes.

In another situation, a communication device may be coupled to a client device, such as a personal computer, or a wireless device such as a personal digital assistant device (“PDA” device). An example of this embodiment includes a personal computer with telephonic capabilities incorporated within the functionality of the computer, wherein the telephonic capabilities may be operated via the user interface of the personal computer. Another example of this embodiment includes a wireless device communicatively coupled to another device such as a personal digital assistant device (“PDA” device), wherein the user may control the operation of the communication device via the interface of the PDA device.

Currently, in this situation, a user may change instant messaging presence to reflect an event in the calendar of the communication device via the user interface of the client device. This process also inconveniences the user, for the user must take the additional step of changing the instant messaging presence via the client device for each event in the calendar which requires a change in instant messaging presence.

Therefore, there is a need in the art for an apparatus and method for changing the instant messaging presence of a user profile relative to a calendar function. There is also a need for an implementing such a feature to save the user the step of changing the instant messaging presence of the communication device for each event in the calendar, even when the communication device is coupled to a client device.

### SUMMARY OF THE INVENTION

Generally stated, the present invention provides a method and apparatus for automatically changing the instant messaging presence of a user profile on a telecommunications network. In particular, the present invention provides a method and apparatus for changing the instant messaging presence of a user profile active in a communication device on a telecommunications network relative to a the occurrence of an event stored in a calendar function for the communication device.

In the first embodiment, the method first comprises the steps of receiving an indication of the occurrence of an event in the calendar function for the communication device. The calendar function may reside on the communication device, the telecommunications network, or in an external memory unit. The events in the calendar function for the communication device can be programmed by the user into the communication device or may be preprogrammed into the communication device. These events include, but are not limited to, recurring events, all-day events, or any other events with a set start time and termination time. After receiving a signal that the time for an event scheduled in the calendar function has arrived, the instant messaging presence of the user profile that is active in the communication device changes to the instant messaging presence associated with the event. The user may program a specific instant messaging presence to be associated with each event, or the instant messaging presence could be preprogrammed into the communication device, an external memory, or the telecommunications network.

In the second disclosed embodiment, the method includes changing the instant messaging presence of a user profile in response to the occurrence of an event in the calendar function of a communication device coupled to a client device. In this embodiment, the calendar function may reside on the client device, in addition to residing on the communication device, an external memory, or on the telecommunications network. Once the time for the event arrives, the presence of the user profile is changed to the presence associated with the event. In this second embodiment, the instant messaging presence associated with each event may be stored in the client device, as well as in the communication device, an external memory, or the telecommunications network.

Therefore, it is an object of the present invention to provide a rapid and user friendly process for changing the instant messaging presence of a user profile on a telecommunications network relative to the occurrence of an event stored in a calendar function for a communication device.

It is also an object of the present invention to provide a process for changing the instant messaging presence of a user profile relative to the occurrence of an event stored in a calendar function for a communication device when the communication device is coupled to a client device.

It is a further object of the present invention to provide an apparatus for changing the presence of a user profile on a telecommunications network relative to the occurrence of an event stored in a calendar function for a communication device.

That the present invention and the preferred embodiment thereof overcome the drawbacks set forth above and accomplish the objects of the invention set forth herein will become apparent from detailed description of the present invention to follow.

### BRIEF DESCRIPTION OF THE DRAWINGS

FIG. 1 is a block diagram representation illustrating an exemplary system in accordance with the first embodiment of the present invention.

FIG. 2 is a block diagram representation of the data storage unit of the communication device in accordance with the first and second embodiments of the present invention.

FIG. 3 is a block diagram representation of an exemplary system in accordance with the second embodiment of the present invention.

FIG. 4 is a flow diagram illustrating the first embodiment of the present invention from the perspective of the communication device.

FIG. 5 is a flow diagram illustrating the second embodiment of the present invention from the perspective of the system.

### DETAILED DESCRIPTION OF THE INVENTION

Reference will now be made in detail to the first and second embodiments of the invention, examples of which are illustrated in the accompanying drawings. Wherever possible, the same reference numbers will be used throughout the drawings to refer to the same or like parts. Generally stated, the present invention provides a method and apparatus for changing the presence of a user profile on a telecommunications network. In particular, the present invention provides a method and apparatus for changing the presence of a user profile on a telecommunications network relative to a calendar function for a communication device.

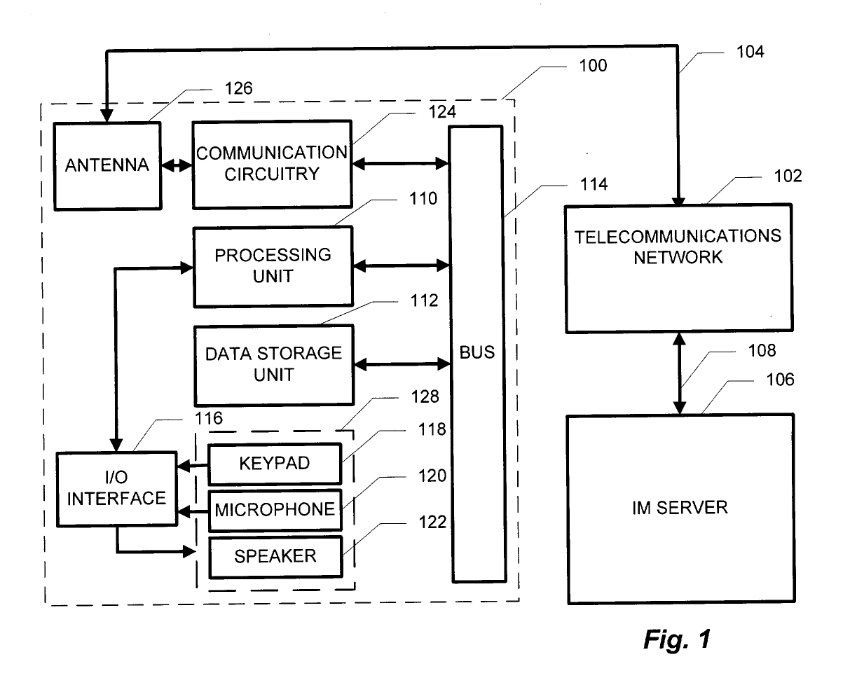

FIG. 1 is an overall system diagram illustrating the exemplary system in accordance with the first embodiment of the present invention. The communication device 100 places and receives calls with telecommunications network 102, in addition to any other communications, via a bi-directional communications link 104. Instant messaging server 106 may also communicate with communication device 100, and is coupled to telecommunications network 102 via a bi-directional communications link 108.

Communication device 100 may be any device capable of receiving and transmitting data. In the first embodiment of the present invention, this communication device 100 is a mobile device such as a cellular telephone. Communication device contains a processing unit 110 which is communicatively coupled via bi-directional communications link to the other components of the communication device via a bus 114.

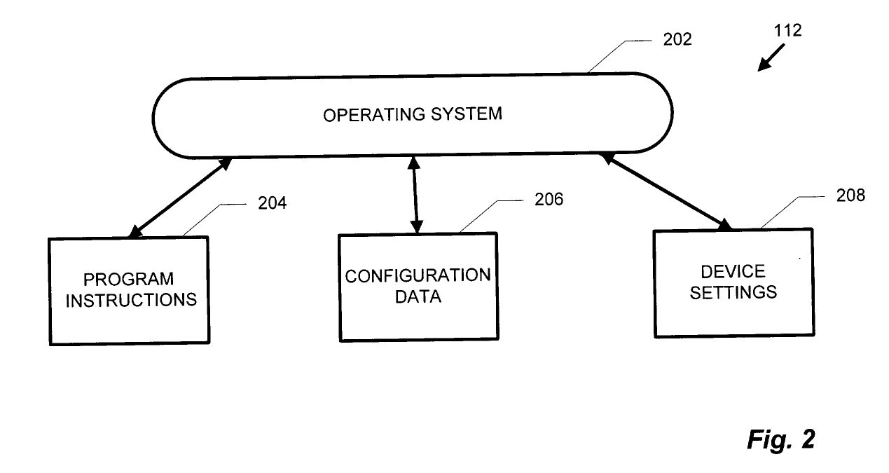

Communication device 100 contains a data storage unit 112, which is discussed in greater detail in FIG. 2. Data storage unit 112 may be any type of memory, including but not limited to RAM, EPROM, or EEPROM memory, and may store either volatile or non-volatile memory. The processing unit 110 and the data storage unit 112 may communicate via a system bus 114. Alternatively, the processing unit 110 and the data storage unit 112 may be included on the same microprocessing chip.

Communication device 100 also includes I/O interface 116, which may reside on the same microprocessing chip as the processing unit 110. However, I/O interface 116 may also reside on an external unit. I/O interface 116 connects the processing unit 110 to a user interface 128. In the case of a wireless device such as a cellular telephone, user interface 128 comprises keypad input 118, microphone input 120, and speaker output 122. The I/O interface 116 may include an analog-to-digital converter for converting an analog microphone signal to a digital signal for use by the processing unit 110. I/O interface 116 may also include a digital-to-analog converter to convert digital information from the processing unit 110 to the speaker 122, such as voice data.

The processing unit 110 transmits and receives digital signals which are to be communicated outside the communication device 100 via the communication circuitry 124. In a cellular telephone embodiment, the communication circuitry 124 is connected to an antenna 126, which communicates signals through airwaves to telecommunications network 102 via a bidirectional communication link 104. The bi-directional communications link 104 is established when a call is placed to or from the communication device 100, or when another activity involving the utilization of bandwidth occurs with communication device 100.

Telecommunications network 102 includes various components required to enable communication between two or more communication devices, including wired connections, wireless connections, switches, and other devices for establishing communication in the network.

Telecommunications network 102 is also communicatively coupled to an instant messaging server 106 via a bidirectional communication link 108. The instant messaging server 106 may be any computer server interacting with the telecommunications network that provides messaging services for communication devices via telecommunications network 102, including but not limited to, an instant messaging client for a wireless services carrier.

The calendar function utilized in conjunction with the first and second embodiments of the present invention, as described below, may reside within communication device 100, such as within data storage unit 112. Alternatively, the calendar function may reside in an external memory, such as a memory within instant messaging server 106, or another memory accessible via telecommunications network 102.

FIG. 2 is a block diagram representation of the data storage unit 112 of the communication device in accordance with the first and second embodiments of the present invention. Data storage unit 112 comprises operating system 202, which contains instructions for operating the communication device 100. The program instructions unit 204 includes instructions for the processing unit to execute the methods disclosed in the first and second embodiments of the present invention, in addition to any other instructions. The configuration data unit 206 is also included in the data storage unit 112, and contains configuration information regarding the assortment of components that make up the system of the present invention.

The data storage unit 112 further comprises a device settings unit 208. The device settings unit 208 contains various parameters indicating the settings of the communication device 100, in addition to any other data. One of these parameters may include a value for indicating the presence associated with a particular event scheduled in the calendar function. This value for a particular event scheduled in the calendar function may be programmed by the user, or may be preprogrammed in the communication device. Other device settings which may be stored in the device settings unit 208 include, but are not limited to, ring type, touch tone type, or appearance of the user interface 128.

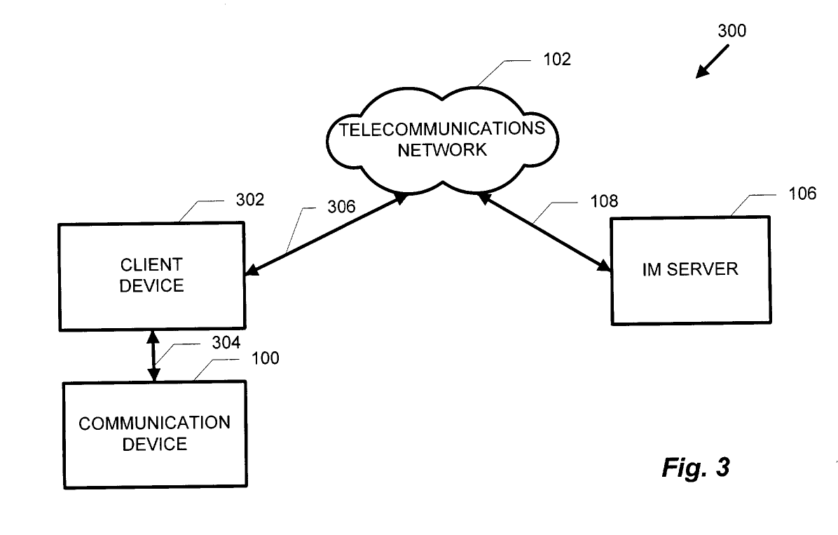

FIG. 3 is a block diagram representation of an exemplary system in accordance with the second embodiment of the present invention. System 300 involves a communication device 100 connected to a client device 302. In this second embodiment, the communication device 100 is the same communication device 100 described in FIG. 1. Communication device 100 is connected via a bidirectional communications link 304 to client device 302. Bi-directional link 304 may be a wireless link, established via a wireless data transfer protocol such as the Bluetooth technology, or a wired connection.

The client device 302 contains substantially the same components as the communication device 100 as described in FIG. 1. However, the client device 302 may comprise any device capable of operating with a communication device 100 such as a personal computer or another wireless device. Bi-directional communication link 306 communicatively couples the client device 302 and the telecommunications network 102. Bi-directional link 306 may be a wireless link, established via a wireless data transfer protocol such as the Bluetooth technology, or alternatively, a wired connection.

Instant messaging server 106 is any computer system interacting with the telecommunications network 102 that provides messaging capabilities for users of telecommunications network 102, including but not limited to, a server owned by a wireless services carrier. The instant messaging server 106 communicates information, such as the current instant messaging presence, to the telecommunications network 102 via bi-directional communications link 108 which also may be a wired or wireless connection. The information then is transmitted to the client device 302 via bi-directional communications link 306.

The calendar function utilized in conjunction with the first and second embodiments of the present invention, as described below, may reside within communication device 100 or within client device 302. Alternatively, the calendar function may reside in an external memory, or another memory accessible via telecommunications network 102.

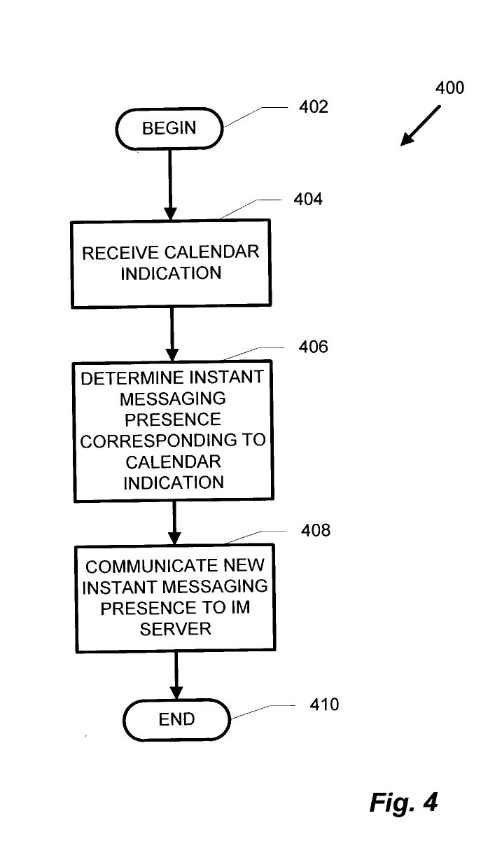

FIG. 4 is a flow diagram illustrating the method of the first embodiment of the present invention. Method 400 begins at step 402 and proceeds to the receipt of an event indication signifying that an event scheduled in the calendar function for the communication device has occurred at step 404. The generation of the event indication may be in response to one or more of various events depending on the capabilities and functionality of the communication device 100, as well as user preferences, including but not limited to the arrival of a time for an event scheduled in the calendar or the arrival of a pre-selected time before an event scheduled in the calendar. The events scheduled in the calendar may be stored in the same location as the calendar function, which may be a memory located within communication device 100 or a memory coupled to communication device 100.

At step 406, the communication device 100 determines the new presence corresponding to the event in the calendar. A specific presence may be associated with different scheduled events in the calendar, or a single presence can be associated with all scheduled events in the calendar. These presences, and the corresponding event information, may be stored in the memory of the communication device 100 in the device settings unit 208 of the data storage unit 112. However, these presences may also reside externally in an alternate memory or in another memory located in the telecommunications network. The presence associated with each event may be programmed by the user via the user interface 128 of communication device 100, may be pre-programmed into the device settings component 208 of the data storage unit 112 of communication device 100 at the time of manufacture, or may reside on the telecommunications network 102 for access by the communication device 100.

At step 408, the communication device changes the presence of the user profile active in the communication device 100 to the new presence associated with the event triggering active call mode. This step involves communicating the new presence to the telecommunications network, which stores the new presence corresponding to the user profile in the IM server 130. This new presence is then communicated to any communication devices containing the user profile on their personal list, so that the new presence for the user profile is displayed on the personal list. The method 400 concludes at step 410 after the presence of the user profile active in the communication device 100 is changed to the presence associated with the event.

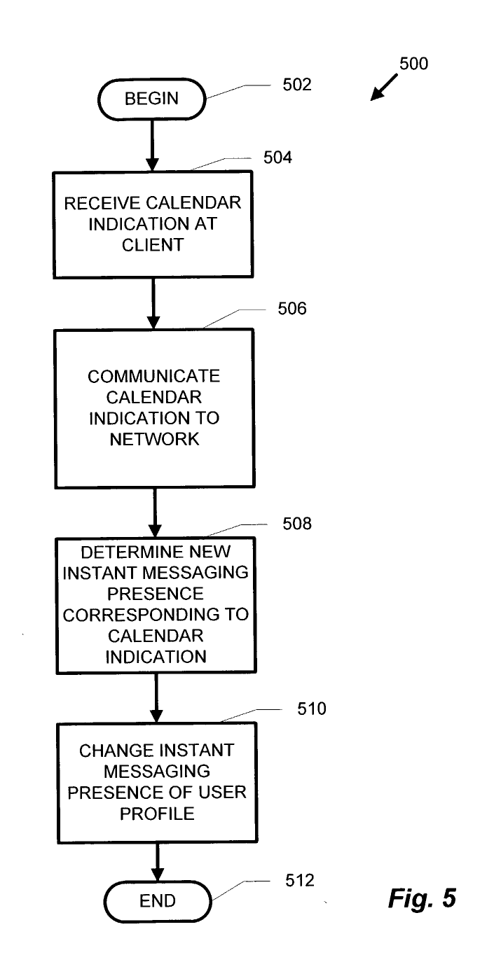

FIG. 5 is a flow diagram illustrating the second embodiment of the present invention. Method 500 is utilized when the communication device 100 is connected to a client device 302 in accordance with the second embodiment of the present invention. After method 500 begins at step 502, the client device 302 receives an indication that an event in the calendar has occurred at step 504. The possible forms for the indication include, but are not limited to, a signal received from the processing unit 110, a signal received from the activation of a dedicated button on the body of communication device 100, or receipt of a particular key sequence from keypad 118 via user interface 128. Furthermore, the instant messaging presence for events in the calendar function may be user-defined or may be preprogrammed into either the communication device 100 or the client device 302.

At step 506, the client device 302 communicates the indication that an event in the calendar function has occurred to the communication device 100. The client device 302 may communicate to the communication device 100 in any capable form, including but not limited to a wireless technology, such as a short-range radio technology including Bluetooth, or a wired connection.

At step 508, the communication device 100 determines the presence corresponding to the event triggering active call mode. The presence corresponding with the event may be stored, for example as a numerical value, in memory of the communication device 100, or also may reside in an external memory. At step 510, the communication device 100 communicates the new presence to the client device 302. This communication may take a number of forms depending on the configuration of the communication device and client device, including but not limited to, over-the-air transmission or communication via a wired link to a cradle device containing the communication device or client device.

The client device, after receiving the new presence at step 510, communicates the new presence to the instant messaging server 106 via the telecommunications network 102. Method 500 concludes at step 512 after the instant messaging presence of the user profile active in the communication device 100 is changed to the presence associated with the event triggering active call mode.

It will be apparent to those skilled in the art that various changes and modifications of an obvious nature may be made to the present invention, and all such changes and modifications are considered to fall within the scope of the appended claims. Other embodiments of this invention will be apparent to those skilled in the art from consideration of the specification and practice of the invention disclosed herein. It is intended that the specification and examples be considered as exemplary only, and within the scope and spirit of the invention as indicated in the description and the following claims.

I hereby claim:

1. A method of changing the presence of a user profile on a telecommunications network relative to a calendar function for a communication device, said method comprising:
receiving an indication that an event on the calendar function has occurred;
determining the new presence corresponding to the event; and
communicating the new presence corresponding to the event to the telecommunications network.

2. The method of claim 1, wherein said determining presence corresponding to the event comprises retrieving the presence corresponding to the event from a memory.

3. The method of claim 2, wherein retrieving the presence corresponding to the event from a memory comprises accessing a memory coupled to the telecommunications network.

4. The method of claim 2, wherein retrieving the presence corresponding to the event from a memory comprises accessing a memory located within the communication device.

5. The method of claim 1, wherein said communication device comprises a wireless device.

6. The method of claim 5, wherein said communication device is a cellular telephone.

7. The method of claim 6, wherein said cellular telephone is communicatively coupled to a client device.

8. A method of changing the presence of a user profile on a telecommunications network relative to a calendar function for a communication device, said method comprising:
receiving an indication that an event on the calendar function has occurred;
communicating the indication to the communication device;
determining a presence corresponding to the event; and
changing the presence of the communication device to the presence corresponding to the event.

9. The method of claim 8, wherein said determining presence corresponding to the event comprises retrieving the presence corresponding to the event from a memory.

10. The method of claim 9, wherein retrieving the presence corresponding to the event from a memory comprises accessing a memory coupled to the telecommunications network.

11. The method of claim 9, wherein retrieving the presence corresponding to the event from a memory comprises accessing a memory located within the communication device.

12. The method of claim 8, wherein said communication device comprises a wireless device.

13. The method of claim 12, wherein said communication device is a cellular telephone.

14. The method of claim 12, wherein said cellular telephone is communicatively coupled to a client device.

15. A apparatus for changing the presence of a user profile on a telecommunications network based at least in part on a calendar function for a communication device, said apparatus comprising:
a processing unit resident in the communication device;
a memory accessible to the processing unit for storing a presence value related to an event stored in the calendar function for the communication device, said event being representative of particular time period; and
a plurality of instructions executable by said processing unit to cause alteration of the presence value of the communication device based at least in part on the time period of said event.

16. The apparatus of claim 15, wherein said system further comprises a network interface communicatively connected to said processing unit for transmission of the new presence value from the communication device to the telecommunications network.

17. The apparatus of claim 16, wherein said calendar function resides on said telecommunications network, and said calendar function is accessed via said network interface.

18. The apparatus of claim 15, wherein said memory further comprises said instructions for providing said calendar function.

19. The apparatus of claim 15, wherein said calendar function resides on an external memory unit.

20. The apparatus of claim 15, wherein said memory accessible to the processing unit further comprises instructions for providing said calendar function.
